(19) United States
(12) Patent Application Publication
(10) Pub. No.: US 2005/0278506 A1
(43) Pub. Date: Dec. 15, 2005

(54) Controller having decoding means

(75) Inventors: Franz Klug, Munich (DE); Oliver Kniffler, Munich (DE); Steffen Marc Sonnekalb, Taufkirchen (DE); Andreas Wenzel, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/132,145

(22) Filed: May 20, 2005

(30) Foreign Application Priority Data
May 24, 2004 (DE) 10 2004 025 418.4

(51) Int. Cl. G06F 9/30

(52) U.S. Cl. 712/208

(57) ABSTRACT

A controller has a receiver for receiving an instruction, the instruction being an executable instruction or a wildcard instruction. A decoder is formed to output a control signal corresponding to the executable instruction responsive to an executable instruction, and to output a switch signal responsive to a received wildcard instruction. Additionally, the controller has a provider for providing a predetermined substitute control signal outputting the predetermined substitute control signal depending on the switch signal.

### CROSS-REFERENCE TO RELATED APPLICATION

This application claims priority from German Patent Application No. 10 2004 025 418.4, which was filed on May 24, 2004, and is incorporated herein by reference in its entirety.

### BACKGROUND OF THE INVENTION

1. Field of the Invention

The present invention relates to a controller having decoding means and to a method for decoding, as is employed in controllers, such as, for example, microprocessors.

2. Description of the Related Art

Microprocessors or, in general, controllers are controlled by instructions united in an instruction set. A program executed by a controller consists of instructions of this kind. The controller is formed to process instructions and to execute the function specified by a respective instruction. For this, the controller comprises decoding means converting the instructions to be executed into control signals. The control signals cause a calculating unit of the controller to execute the function defined by the instruction to be executed. At present, well-known microprocessors usually use a fixed predetermined instruction set predetermining a certain functionality. This instruction set is only a part of all operations possible which are theoretically executable on hardware, i.e. a controller. When a certain algorithm is implemented by a programmer, he can only fall back on this set of instructions.

This regulation is of considerable disadvantage, in particular for programmers programming highly special algorithms. The XTIME operation, discussed and illustrated as a pseudo machine code below, in an AES software implementation, software executing the symmetrical cryptographic algorithm AES, is to be mentioned here as an example.
XTIME .macro r1, r2
and D8, r1, D14
sh D8, −7
mul.u r2, D8, 0x1b
and D8, r1, D15
sh D8, 1
xor r2, D8
.endm

Two variables, r1, r2, are input into the macro called XTIME. The macro accesses the registers, called D8, D14, D15, of an 88 CPU. In a first AND operation, called “and”, the value r1 is subjected to an AND operation with the register value D14 and the result is written to the register D8. Subsequently, a shift operation, called “sh”, shifting the value of the register D8 by seven positions to the right, is executed. In a subsequent multiplication operation, called “mul.u”, the value of the register D8 is multiplied by a value at a memory position called 0x1b, and the result is written to the variable r2. After that, the AND operation, called “and”, performing an AND operation of the value r1 with the value of the register D15 and writing the result into the register DB is executed. Subsequently, the shift operation “sh” shifting the value of the register D8 to the left by one is performed. The last operation in the macro is an XOR operation, called “xor”, executing an XOR operation between the value r2 and the register value D8 and writing the result to the variable r2. The macro XTIME is terminated by a return function .endm.

This sequence contains a series of an AND operation “and” and a subsequent shift operation “sh”. This series is executed twice in the macro. Repetitive instruction flows of this kind are of disadvantage in that they unnecessarily slow down a program execution and, additionally, unnecessarily increase a storage demand of the program. In order to avoid these disadvantages, highly recurring instruction sequences are incorporated in the architecture of a controller. This results in an extension of the instruction set having complex instructions corresponding to a combination of several original instructions. An extension of the instruction set, however, entails great expenditure. This particularly includes redeveloping parts of the controller core called CORE including respective verification, layout measures and additional area overhead required for implementing the complex instruction extensions. An instruction set extension of this kind will consequently not be introduced for special instruction combinations rarely required.

Reconfigurable CPUs are only basically present in FPGA solutions which can, however, not be employed for controllers fixedly cast in hardware.

Well-known controller architectures only allow extending an instruction set with a macro instruction set via a decoding ROM added. When using a decoder ROM, the additional macro instructions are cast in hardware and thus already established when developing a controller. Additional macro instructions of this kind do not differ at all from the original instruction set of a controller as regards their flexibility.

### SUMMARY OF THE INVENTION

It is an object of the present invention to provide a controller having decoding means and a method for decoding and a computer program for executing the method, having greater flexibility.

In accordance with a first aspect, the present invention provides a controller having: a receiver for receiving an instruction, the instruction being an executable instruction or a wildcard instruction; a decoder formed to output a control signal corresponding to the instruction responsive to the received instruction being an executable instruction and to output a switch signal responsive to the received instruction being a wildcard instruction; and a provider formed to output a predetermined substitute control signal depending on the switch signal.

In accordance with a second aspect, the present invention provides a method for decoding having the steps of: (a) receiving an instruction, the instruction being an executable instruction or a wildcard instruction; (b) outputting a control signal corresponding to the executable instruction responsive to the received instruction being an executable instruction, and outputting a switch signal responsive to the received instruction being a wildcard instruction; and (c) outputting a predetermined substitute control signal depending on the switch signal.

In accordance with a third aspect, the present invention provides a computer program having a program code for performing the above mentioned method when the computer program runs on a computer.

### BRIEF DESCRIPTION OF THE DRAWINGS

Preferred embodiments of the present invention will be detailed subsequently referring to the appended drawings, in which:

FIG. 1 is a schematic illustration of a controller according to the present invention;

FIG. 2 is a detailed schematic illustration of another embodiment of a controller according to the present invention; and

FIG. 3 is a schematic illustration of another embodiment of a controller according to the present invention.

### DESCRIPTION OF THE PREFERRED EMBODIMENTS

In the subsequent description of the preferred embodiments of the present invention, same or similar reference numerals will be used for elements illustrated in different drawings and having similar effects, a repeated description of these elements being omitted.

The present invention is based on the finding that an improved utilization of the theoretical possibilities of a microcontroller system may be enabled using resources already present. Additionally required means for providing may be realized adding a small additional area and a wildcard instruction only requires a reserved op-code in the instruction set present.

The inventive approach is based on a novel possibility of realizing an extension of the instruction set present on a microprocessor without implementing and testing specific hardware for each additional instruction. A programmer can thus perform his personal extensions required within the possibilities of the system. This is of particular value for programmers requiring special instructions, which are usually very rare, which have no meaning for the entire system and are thus not implemented in the architecture of the controller. These extensions allow reducing the memory space of a system and increasing the performance when executing a program.

According to the present invention, a decoder is allowed to change instructions. This is how a reconfigurable instruction can be programmed. In particular, reloadable programs can use instructions self-defined afterwards which were not known before. This, on the one hand, increases the flexibility of the CORE and, on the other hand, produces a new kind of security since a programmer can generate his own instructions. When the inventive approach is employed for safety-relevant applications, an attacker cannot deduce from the op-code which instruction the programmer will execute.

An essential security aspect in this context is the possibility to develop one or several private instruction sets and thus to block a possible attacker better. According to another embodiment, predetermined substitute control signals are placed in a memory. Thus, an attacker cannot find out what a program is executing even if he succeeds in cracking the op-code.

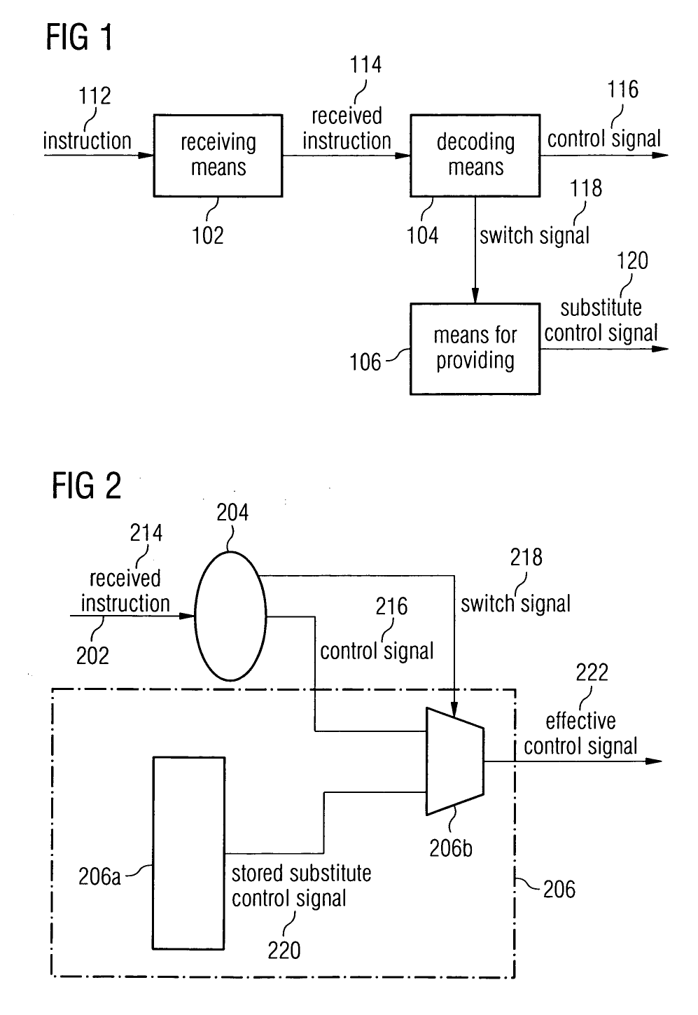

FIG. 1 shows a schematic illustration of a controller according to the present invention. The controller comprises receiving means 102, decoding means 104 and means 106 for providing. The receiving means 102 is formed to receive an instruction 112. A received instruction 114 is provided to the decoding means 104 by the receiving means 102. The received instruction 114 is either an instruction executable by the controller or a wildcard instruction. An executable instruction is converted to a control signal 116 by the decoding means 104, the control signal 116 being output by the decoding means 104. The control signal 116 controls a calculating unit (not shown in FIG. 1) of the controller and causes the calculation unit to execute a function defined by the executable instruction. If the received instruction 114 is a wildcard instruction, the decoding means 104 will output a switch signal 118 received by the means 106 for providing. The switch signal 118 indicates to the means 106 for providing that a wildcard instruction has been received.

Responsive to a wildcard instruction, the means 106 for providing outputs a predetermined substitute control signal 120. The substitute control signal 120 also controls the calculating unit of the controller and causes it to execute an additional function. Preferably, the additional function is a function which cannot be invoked by a control signal 116. Thus, the additional function corresponds to a function not yet defined by an instruction 112 of an instruction set of the controller, but corresponds to a function extending the instruction set defined for the controller. The instruction set usually comprises a plurality of executable instructions and the wildcard instruction.

Alternatively, the wildcard instruction may be an executable instruction which is, however, recognized in the decoding means 104 and will not be decoded. The substitute control signal may also be a control signal corresponding to an instruction of the instruction set.

Preferably, the additional function corresponds to a function which the calculating unit provides anyway to be able to execute the instructions of the instruction set. The additional function, however, is not executable by an instruction of the instruction set. Exemplarily, the additional function corresponds to a combination of functions invoked by instructions 112 of the instruction set. According to the present invention, the additional function is triggered by the substitute control signal 120. The additional function can be executed by this, even though there is neither a corresponding instruction 112 in the instruction set of the controller nor is the decoding means 104 formed to convert such an instruction to a corresponding control signal.

The wildcard instruction causing the means 106 for providing to output the substitute control signal 120 may be an additional instruction 112 of the instruction set or an instruction 112 of the instruction set labeled to, up to then, as reserved. In the case of the reserved instruction, no change is required in a prior-art instruction set.

Preferably, the substitute control signal 120 output by the means 106 for providing may be exchanged. This allows outputting different substitute control signals 120 using a single wildcard instruction and thus having different additional functions be executed by the controller.

Subsequently, the inventive method will be discussed referring to the XTIME operation already described. As has been mentioned, the sequence comprises two times a shift operation “sh” following an AND operation “and”. An instruction which may execute these two operation in a single instruction cycle could be constructed in the 88 CPU already mentioned. This means that the calculating unit of the CPU is designed for this by virtue of its architecture. Such an AND shift operation “andsh”, however, will not exist since this instruction is very specific for this algorithm. The XTIME macro, however, is so frequent in the AES implementation that the performance of the algorithm could be increased by 10% by a corresponding optimized instruction “andsh”. A 16-byte op-code could be substituted in the XTIME macro by 2 bytes by means of a substitute control signal 120 corresponding to the “andsh” operation, the signal being output by the means 106 for providing responsive to a wildcard instruction. All in all, about 220 bytes op-code could be saved for the AES by means of such a solution. Since the algorithm of the AES has a code size of about 2 kbytes, the result is a code size reduction of about 10%.

Thus, the present invention allows executing additional functions which cannot be invoked by an instruction 112 of the instruction set.

The control signal 116 and the substitute control signal 120 make control signal values available to the calculating unit of the controller. Typically, the control signal values are not transferred to the calculating unit in a series, but in parallel via several lines (not shown). The instructions 112 are usually 16-bit or 32-bit instructions, may, however, also comprise any other bit width. Preferably, the wildcard instruction comprises a small bit width to occupy the least possible memory space. An instruction is typically a machine-readable instruction comprising an op-code and an operand. The op-code defines an instruction to be executed by the instruction. Op-codes are usually short and limited by the instruction set. An operand defines values to be processed by the op-code, the values being transferred directly or being present in registers or memories. Operands are only limited by a system architecture.

The receiving means 102 is usually realized as an input buffer of the controller. In this case, the instructions 112 are clocked by the receiving means 102 and output as instructions 114 received. Alternatively, the receiving means 102 may also be realized as a simple transit line or as amplifying means. The decoding means 104 is extended by the functionality of outputting the switch signal 118 in response to the wildcard instruction. For this, the decoding means 104 comprises comparing means (not shown in the drawings) formed to recognize the wildcard instruction.

FIG. 2 shows a detailed schematic illustration of a controller according to the present invention. The controller shown in FIG. 2 comprises receiving means 202 which in this embodiment is realized as a transit line, and decoding means 204. Means 206 for providing is realized by memory means 206a connected to switching means 206b. Since the receiving means 202 is a transit line, an instruction 214 received corresponds to an instruction or op-code as it is received by the receiving means in FIG. 1. The decoding means 204 executes a decoding function and outputs, as has already been described in FIG. 1, a control signal 216 and a switch signal 218. A substitute control signal 220 stored is provided by the memory means 206a. The memory means 206a, in this embodiment, is a register and, in particular, a CSFR register (CFSR=core special function register). All general-purpose registers fall under the generic term CSFR. CFSR registers are required to precisely describe and control the state of a processor. The memory means 206a provides the substitute control signal 220 to the switching means 206b. The switching means 206b is a multiplexer.

The multiplexer 206b receives the control signal 216 and the substitute control signal 220. The multiplexer 206b is also connected to the switch signal 218. The switch signal 218 in turn indicates whether the instruction 214 received is an executable instruction converted by the decoding means 204 to the control signal 216 or is a wildcard instruction. If the switch signal 218 indicates an executable instruction, the multiplexer 206b will connect through the control signal 216 to the multiplexer output. The multiplexer 206b will output an effective control signal 222. In case the switch signal 218 indicates an executable instruction, the effective control signal 222 will correspond to the control signal 216. In case the switch signal 218 indicates a wildcard instruction, the multiplexer 206b will connect through the substitute control signal 220 and the effective control signal 222 will thus correspond to the substitute control signal 220. Consequently, the multiplexer 206b will output either the control signal 216 or the substitute control signal 220 depending on whether the instruction 214 received is an executable instruction or a wildcard instruction.

The elements of the controller shown in FIG. 2 correspond to the elements of a decoder of a controller. The decoder is enabled to change instructions by multiplexing an op-code stream corresponding to a sequence of instructions 214 received and the contents of the CSFR register 206a corresponding to the substitute control signal 220. This is how a reconfigurable instruction can be programmed. A new instruction can be multiplexed to the controller or a CPU by programming the CSFR register 206a and by using an addition op-code in the form of the wildcard instruction. A new instruction can be defined in the 88 processor by writing on the additional CSFR by means of an MTCR operation (MTCR=move to core register). The MTCR operation explicitly shifts data from the CPU to a CSFR register. In this case, an additional 16-bit op-code corresponding to the wildcard instruction is interpreted by the decoder such that the additional multiplexer 206b will be switched and a new defined instruction in the form of the substitute control signal 220 will be executed instead of a decoded instruction in the form of the control signal 216. The new instruction will be executed by the effective control signal 222 formed by this, corresponding to the substitute control signal 220. The CFSR register 206a is thus used to control the CPU (not shown) using a single predefined op-code.

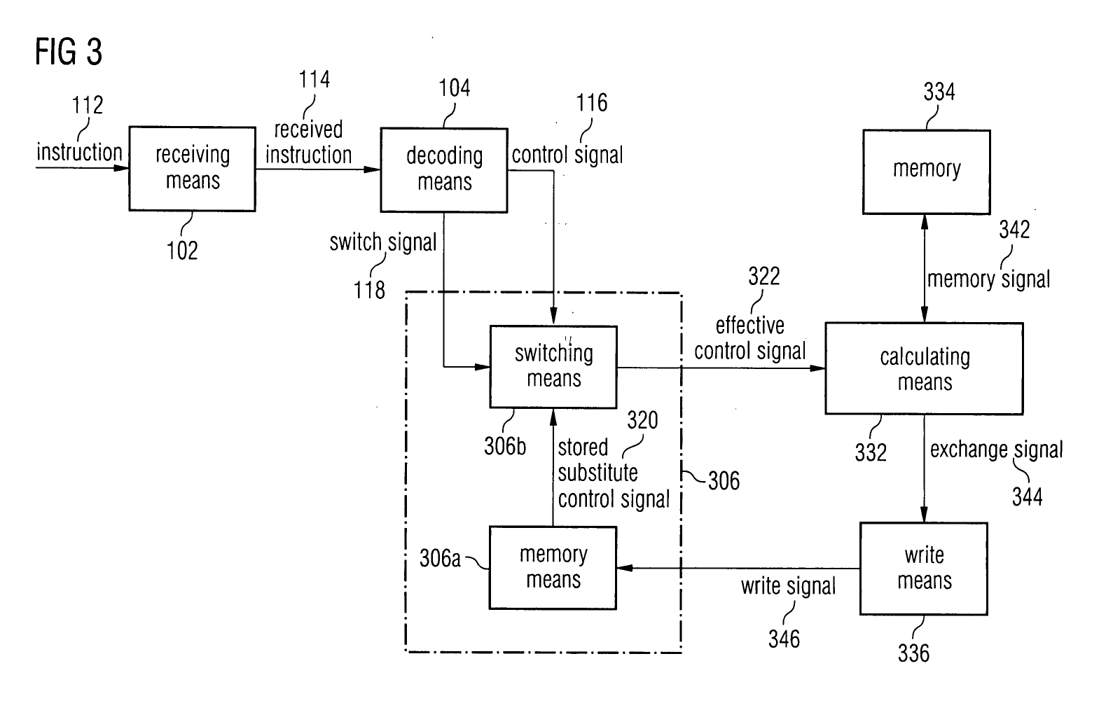

FIG. 3 shows a schematic illustration of another embodiment of the present invention. Apart from the elements already discussed in the previous figures in the form of receiving means 102 and decoding means 104, the embodiment shown in FIG. 3 comprises memory means 306a and switching means 306b. The switching means 306b thus corresponds to the switch signal shown in FIG. 2 and is formed to output an effective control signal 322 which, depending on the switching means 118, corresponds to either the control signal 116 or a stored substitute control signal 320. The effective control signal 322 is received by calculating means 332. The calculating means is connected to a memory 334 and to writing means 336. The calculating means 332 is connected to the memory 343 via a write signal 342 and connected to the writing means 336 via an exchange signal 344.

The calculating means 332 is formed to execute a function controlled by the effective control signal 322. The function to be executed will correspond to a function defined by an executable instruction if the effective control signal 322 corresponds to the control signal 116. In case the effective control signal 322 corresponds to the substitute control signal 320, the function executed by the calculating means 332 will correspond to an additional function. Implemented instructions may be mapped to the wildcard instruction. An attacker knows what logical operation an op-code executes, the wildcard instruction, however, is not defined for the attacker.

Preferably, the substitute control signal 320 is defined controlled by a program. For this, the instruction set usually comprises a write instruction causing the calculating means 332 to provide a write signal 346 to the memory means 306a via the writing means 336. A value of the substitute control signal 320 is established via the write signal 346. This value of the substitute control signal 320 will be stored in the memory means 306a until it is overwritten by a new value of the write signal 346. The value of the substitute control signal 320 written to the memory means 306a via the write signal 346 is either contained in the write instruction or read out from the memory 334 and provided to the memory means 306a via the writing means 336. The values of the substitute control signal 320 or a plurality of different substitute control signals may be stored fixedly in the memory 334 or be written to the memory cells of the memory 334 by further program-controlled write instructions.

This embodiment allows filing instructions in the form of substitute control signal values in a memory, such as, for example, in the form of an NVM memory (NVM=non volatile memory) as a generic term for all non-volatile memories, such as, for example, an EEPROM, loading same to a register file (not shown in FIG. 3) and writing same to the memory means 306a in the form of a CSFR register by means of an MTCR operation and executing them by an op-code in the form of a wildcard instruction not containing any information on the operation stored in the CSFR and the registers used here. Thus, even a cracked op-code is of no use for an attacker to establish what the program is executing. This is an essential security aspect with safety-relevant applications.

The fact that the substitute control signal 320 may be programmed freely limits a sum of usable instructions only by the architecture of the calculating means. The architecture of the calculating means 332 or the substitute control signal values causing the calculating means 332 to execute additional functions must be known to a programmer or a compiler software converting a program code to machine-readable instructions 112.

The inventive approach is not limited to the embodiments described but may particularly be employed in all devices executing program-controlled instructions. In particular, the instructions may also comprise a structure more simple than the instructions of a programming language shown in the embodiment. The memory means for storing and providing the substitute control signal may be any memory and, in particular, even a register already present in a controller structure.

According to a preferred embodiment, a controller comprises a plurality of memory means for storing substitute control signal values. This allows providing a plurality of substitute control signals by a single wildcard instruction and thus having a complex additional function be executed by the controller. If the memory means is implemented in the form of a CSFR register, several CSFR registers may, for example, be implemented and addressed by a reserved op-code.

According to another embodiment, individual ones of the several memory means storing different substitute control signals 320 may be addressed by different wildcard instructions. In this case, the decoding means provides a complex control signal allowing controlling the individual memory means responsive to the respective wildcard instruction.

Depending on the circumstances, the inventive method for decoding may be implemented in either hardware or software. The implementation may be on a digital storage medium, in particular a disc or a CD having control signals which can be read out electronically, which can cooperate with a programmable computer system such that the respective method will be executed. In general, the invention also includes a computer program product having a program code stored on a machine-readable carrier for performing the inventive method when the computer program product runs on a computer. Put differently, the invention may also be realized as a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A controller comprising:
a receiver for receiving an instruction, the instruction being an executable instruction or a wildcard instruction;
a decoder formed to output a control signal corresponding to the executable instruction responsive to the received instruction being an executable instruction, and to output a switch signal responsive to the received instruction being a wildcard instruction; and
a provider formed to output a predetermined substitute control signal depending on the switch signal.

2. The controller according to claim 1, wherein the provider comprises a memory unit for providing a stored predetermined substitute control signal, and a switch, the switch being formed to output the control signal or the stored predetermined substitute control signal depending on the switch signal.

3. The controller according to claim 1, wherein the provider is formed to receive and store the predetermined control signal.

4. The controller according to claim 2, further comprising a writer formed to write a value of the substitute control signal to the memory unit responsive to a write instruction.

5. The controller according to claim 4, further comprising a memory, wherein the writer is formed to write the value of the substitute control signal from the memory to the memory unit.

6. The controller according to claim 1, further comprising an instruction set having a plurality of executable instructions, a control signal corresponding to each executable instruction and the predetermined substitute control signal corresponding to an additional instruction extending the instruction set.

7. The controller according to claim 1, further comprising a calculator formed to execute an operation determined by the control signal or the substitute control signal responsive to the control signal or the substitute control signal.

8. A method for decoding, comprising the steps of:
(a) receiving an instruction, the instruction being an executable instruction or a wildcard instruction;
(b) outputting a control signal corresponding to the executable instruction responsive to the received instruction being an executable instruction, and outputting a switch signal responsive to the received instruction being a wildcard instruction; and
(c) outputting a predetermined substitute control signal depending on the switch signal.

9. A computer program having a program code for performing a method for decoding comprising the steps of: (a) receiving an instruction, the instruction being an executable instruction or a wildcard instruction; (b) outputting a control signal corresponding to the executable instruction responsive to the received instruction being an executable instruction, and outputting a switch signal responsive to the received instruction being a wildcard instruction; and (c) outputting a predetermined substitute control signal depending on the switch signal, when the computer program runs on a computer.

10. A controller comprising:
means for receiving an instruction, the instruction being an executable instruction or a wildcard instruction;
means for outputting a control signal corresponding to the executable instruction responsive to the received instruction being an executable instruction, and for outputting a switch signal responsive to the received instruction being a wildcard instruction; and
means for providing a predetermined substitute control signal depending on the switch signal.

11. The controller according to claim 10, wherein the means for providing comprises a memory means for providing a stored predetermined substitute control signal, and a switching means for outputting the control signal or the stored predetermined substitute control signal depending on the switch signal.

12. The controller according to claim 10, wherein the means for providing is formed to receive and store the predetermined control signal.

13. The controller according to claim 11, further comprising a means for writing a value of the substitute control signal to the memory unit responsive to a write instruction.

14. The controller according to claim 13, further comprising a memory means, wherein the means for writing is formed to write the value of the substitute control signal from the memory means to the memory unit.

15. The controller according to claim 10, further comprising a calculating means for executing an operation determined by the control signal or the substitute control signal responsive to the control signal or the substitute control signal.
